(19) United States
(12) Patent Application Publication
(10) Pub. No.: US 2020/0041939 A1
(43) Pub. Date: Feb. 6, 2020

(54) FIXING DEVICE AND IMAGE FORMING APPARATUS FOR PRINTING

(71) Applicant: FUJI XEROX CO., LTD., Tokyo (JP)

(72) Inventor: Koichi IMAZU, Kanagawa (JP)

(73) Assignee: FUJI XEROX CO., LTD., Tokyo (JP)

(21) Appl. No.: 16/294,933

(22) Filed: Mar. 7, 2019

(30) Foreign Application Priority Data
Aug. 6, 2018 (JP) 2018-147557

(51) Int. Cl. G03G 15/20

(52) U.S. Cl. CPC G03G 15/2025

(57) ABSTRACT

A fixing device includes a rotary first fixing unit, a second fixing unit that is formed of an endless belt and is in contact with the first fixing unit at a position other than an uppermost point and a lowermost point in a vertical direction to form a fixing nip, and a lubricant retaining unit arranged at a position including the lowermost point to retain a lubricant to be supplied to an inner peripheral surface of the belt.

### CROSS-REFERENCE TO RELATED APPLICATIONS

This application is based on and claims priority under 35 USC 119 from Japanese Patent Application No. 2018-147557 filed Aug. 6, 2018.

### BACKGROUND

### (i) Technical Field

The present disclosure relates to a fixing device and an image forming apparatus.

### (ii) Related Art

As an example of fixing devices, there is a fixing device in which an endless belt is used as a heating member or a pressurizing member and a press contact member that brings the endless belt into press contact with the mating pressurizing or heating member is arranged on an inner side of the endless belt. In this fixing device, a sliding sheet is used for reducing a sliding resistance between the endless belt and the press contact member and a lubricant is applied to the inner peripheral surface of the endless belt (Japanese Unexamined Patent Application Publication Nos. 2014-174358, 2015-225286, and 2016-176993).

Japanese Unexamined Patent Application Publication No. 2014-174358 discloses that a lubricant circulating member that retains a lubricant and supplies the lubricant to a downstream side of a nip of a sliding member by causing the lubricant to adhere to a fixing member is provided on an upstream side of the nip.

Japanese Unexamined Patent Application Publication No. 2015-225286 discloses that a sliding member retains a lubricant, the lubricant retaining capacities of the sliding member in end regions located on both sides of a central region in a longitudinal direction is larger than the lubricant retaining capacity of the sliding member in the central region, and the lubricant retaining capacity of the sliding member is larger at a nip exit than at a nip entrance.

Japanese Unexamined Patent Application Publication No. 2016-176993 discloses that a fabric sliding sheet arranged between a nip forming member and a fixing member and containing a lubricant is twilled and includes a first sheet part in contact with the nip forming member, in which groove directions defined by twill lines are inclined to one side with respect to a rotating direction of the fixing member, and a second sheet part in contact with the fixing member, in which the groove directions are inclined to another side with respect to the rotating direction, and the two sheet parts are layered together.

### SUMMARY

Aspects of non-limiting embodiments of the present disclosure relate to the following case. In a fixing device having a fixing nip arranged at a position except an uppermost point and a lowermost point in a vertical direction, leakage of a lubricant from a lowermost point of a belt in the vertical direction is reduced compared with a case in which a lubricant retaining unit is arranged at a position where the lubricant retaining unit faces the fixing nip.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device comprising a rotary first fixing unit, a second fixing unit that is formed of an endless belt and is in contact with the first fixing unit at a position except an uppermost point and a lowermost point in a vertical direction to form a fixing nip, and a lubricant retaining unit arranged at a position including the lowermost point to retain a lubricant to be supplied to an inner peripheral surface of the belt.

### BRIEF DESCRIPTION OF THE DRAWINGS

Exemplary embodiments of the present disclosure will be described in detail based on the following figures, wherein:

FIG. 1 is a schematic structural view illustrating an image forming apparatus to which a fixing device according to a first exemplary embodiment of the present disclosure is applied;

FIG. 2 is a sectional structural view illustrating the fixing device according to the first exemplary embodiment of the present disclosure;

FIG. 3 is an exploded perspective view illustrating the fixing device according to the first exemplary embodiment of the present disclosure;

FIG. 4 is a schematic view illustrating the fixing device according to the first exemplary embodiment of the present disclosure;

FIGS. 5A and 5B are schematic views illustrating related-art fixing devices;

FIG. 6 is a partially cutaway perspective structural view illustrating the fixing device according to the first exemplary embodiment of the present disclosure;

FIG. 7 is a perspective structural view illustrating a holding member;

FIG. 8 is a schematic view illustrating a pressurizing belt;

FIG. 9 is a plan view illustrating a sliding sheet;

FIGS. 10A to 10D are schematic views illustrating arrangements of a felt member;

FIG. 11 is a sectional structural view illustrating an operation of the fixing device according to the first exemplary embodiment of the present disclosure;

FIG. 12 is a sectional structural view illustrating a related-art fixing device;

FIG. 13 is a sectional structural view illustrating a fixing device according to a second exemplary embodiment of the present disclosure;

FIG. 14 is a sectional structural view illustrating an operation of the fixing device according to the second exemplary embodiment of the present disclosure; and

FIG. 15 is a sectional structural view illustrating a fixing device according to a third exemplary embodiment of the present disclosure.

### DETAILED DESCRIPTION

Exemplary embodiments of the present disclosure are described below with reference to the drawings.

### First Exemplary Embodiment

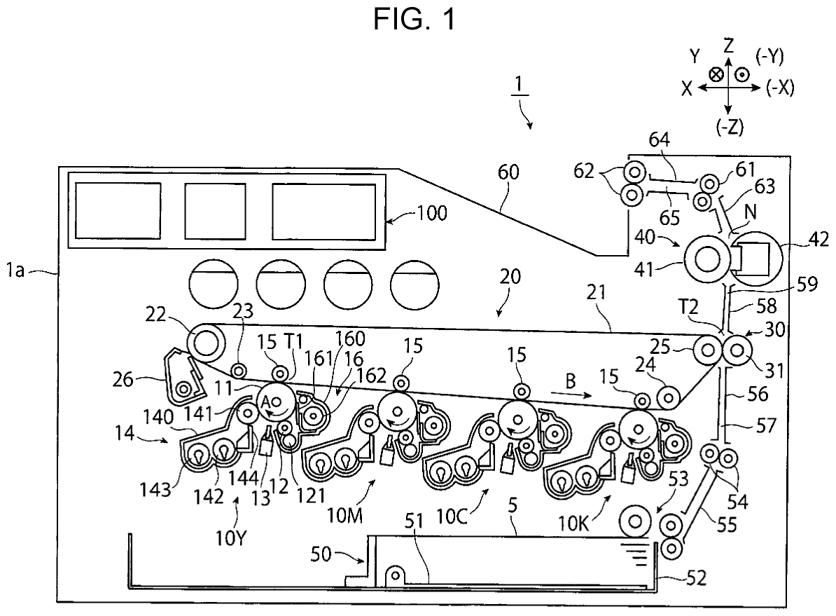

FIG. 1 schematically illustrates an overall image forming apparatus to which a fixing device according to a first exemplary embodiment is applied. In FIG. 1, an arrow X indicates a width direction along a horizontal plane, an arrow Y indicates a depth direction along the horizontal plane, and an arrow Z indicates a vertical direction.

### <Overall Structure of Image Forming Apparatus>

For example, an image forming apparatus 1 is constructed as a color printer. As illustrated in FIG. 1, the image forming apparatus 1 includes a plurality of image forming devices 10 as examples of image forming units that form toner images through development with toner serving as a developer, an intermediate transfer device 20 that carries the toner images formed by the image forming devices 10 and transports the toner images to a second transfer position T2 where the toner images are finally secondly transferred onto recording paper 5 that is an example of a recording medium, a paper feeding device 50 that contains and transports sheets of desired recording paper 5 to be fed to the second transfer position T2 of the intermediate transfer device 20, and a fixing device 40 that fixes the toner images secondly transferred onto the recording paper 5 by the intermediate transfer device 20. Reference symbol 1a represents an apparatus body formed of a support structure member, an outside cover, and the like.

The image forming devices 10 are four dedicated image forming devices 10Y, 10M, 10C, and 10K that form toner images of four colors that are yellow (Y), magenta (M), cyan (C), and black (K), respectively. The four image forming devices 10 (Y, M, C, K) are arranged in line while being inclined with respect to the width direction X within an internal space of the apparatus body 1a.

As illustrated in FIG. 1, each image forming device 10 (Y, M, C, K) includes a rotary photoconductor drum 11 as an example of an image carrying unit. For example, the following devices are arranged around the photoconductor drum 11. The devices are a charging device 12 that charges the peripheral surface of the photoconductor drum 11 where an image may be formed (image carrying surface) at a desired potential, an exposing device 13 that is an example of an electrostatic latent image forming unit that forms an electrostatic latent image (for each color) with a potential difference by irradiating the charged peripheral surface of the photoconductor drum 11 with light based on image information (signal), a developing device 14 (Y, M, C, K) that is an example of a developing unit that develops the electrostatic latent image into a toner image with toner of a corresponding color (Y, M, C, K) that serves as the developer, a first transfer device 15 that is an example of a first transfer unit that transfers the toner image onto the intermediate transfer device 20, and a drum cleaning device 16 that is an example of a cleaning unit that cleans the image carrying surface of the photoconductor drum 11 after first transfer by removing adherents such as residual toner adhering to the image carrying surface.

The photoconductor drum 11 has an image carrying surface having a photoconductive layer (photosensitive layer) made of a photosensitive material on the peripheral surface of a cylindrical or columnar grounded base. The photoconductor drum 11 is supported so as to rotate in a direction indicated by an arrow A by a driving force transmitted from a driving device (not illustrated).

The charging device 12 includes a contact charging roller arranged in contact with the photoconductor drum 11. The charging device 12 is supplied with a charging voltage. If the developing device 14 performs reversal development, a voltage or current having a polarity identical to a charging polarity of the toner to be supplied from the developing device 14 is supplied as the charging voltage. On the back of the charging device 12, a cleaning roller 121 that cleans the surface of the charging device 12 is arranged in contact with the charging device 12.

For example, the exposing device 13 includes an LED print head that forms an electrostatic latent image by irradiating the photoconductor drum 11 with light based on image information from a plurality of light emitting diodes (LEDs) serving as light emitting elements arrayed in an axial direction of the photoconductor drum 11. At the time of latent image formation, image information (signal) input to the image forming apparatus 1 by arbitrary means is transmitted to the exposing device 13. As the exposing device 13, there may be used an exposing device that forms an electrostatic latent image by irradiating the charged peripheral surface of the photoconductor drum 11 with laser light obtained based on image information input to the image forming apparatus 1.

As illustrated in FIG. 1, each developing device 14 (Y, M, C, K) is constructed as follows. For example, a developing roller 141 that retains the developer and transports the developer to a developing region where the developing roller 141 faces the photoconductor drum 11, agitating transport members 142 and 143 such as screw augers that transport the developer while agitating the developer so that the developer passes along the developing roller 141, and a layer thickness regulating member 144 that regulates the amount (layer thickness) of the developer to be retained by the developing roller 141 are arranged in a housing 140 having an opening and a chamber containing the developer. A developing voltage is supplied between the developing roller 141 of the developing device 14 and the photoconductor drum 11 from a power supply (not illustrated). The developing roller 141 and the agitating transport members 142 and 143 rotate in desired directions by driving forces transmitted from driving devices (not illustrated). A two-component developer containing non-magnetic toner and a magnetic carrier is used as the developer of each of the four colors (Y, M, C, K).

The first transfer device 15 is a contact transfer device including a first transfer roller that rotates in contact with the peripheral surface of the photoconductor drum 11 via an intermediate transfer belt 21 at a first transfer position T1 and is supplied with a first transfer voltage. As the first transfer voltage, a DC voltage having a polarity opposite to the charging polarity of the toner is supplied from the power supply (not illustrated).

The drum cleaning device 16 is constructed as follows. For example, a cleaning blade 161 that cleans the photoconductor drum 11 by removing adherents such as residual toner and a sending member 162 such as a screw auger that collects the adherents such as the toner removed by the cleaning blade 161 and sends the adherents to a collecting system (not illustrated) are arranged in a container body 160.

The intermediate transfer device 20 is arranged above the image forming devices 10 (Y, M, C, K). For example, the intermediate transfer device 20 includes the intermediate transfer belt 21 that is an example of an intermediate transfer unit that circulates in a direction indicated by an arrow B while passing through each first transfer position T1 between the photoconductor drum 11 and the first transfer device 15 (first transfer roller), a plurality of belt support rollers 22 to 25 that support the intermediate transfer belt 21 in a desired state from the inner periphery so that the intermediate transfer belt 21 may circulate, a second transfer device 30 arranged on an outer peripheral side (image carrying surface) of the intermediate transfer belt 21 supported on the belt support roller 25 to secondly transfer the toner images on the intermediate transfer belt 21 onto the recording paper 5, and a belt cleaning device 26 that cleans the outer peripheral surface of the intermediate transfer belt 21 by removing adherents such as residual toner or paper dust adhering to the outer peripheral surface after the intermediate transfer belt 21 has passed through the second transfer device 30.

As the intermediate transfer belt 21, there is used an endless belt manufactured by using a material obtained by dispersing a resistance regulator such as carbon black in a synthetic resin such as a polyimide resin or a polyamide resin. The belt support roller 22 is a driving roller. The belt support roller 23 is a surfacing roller that keeps the traveling position of the intermediate transfer belt 21. The belt support roller 24 is a tension applying roller. The belt support roller 25 is a second transfer backup roller.

The second transfer device 30 includes a second transfer roller 31 that rotates at the second transfer position T2 that is a portion of the outer peripheral surface of the intermediate transfer belt 21 supported on the belt support roller 25 in the intermediate transfer device 20. A DC voltage having a polarity identical or opposite to the charging polarity of the toner is supplied to the second transfer roller 31 or the belt support roller 25 of the intermediate transfer device 20 as a second transfer voltage.

For example, the fixing device 40 includes a heating roller 41 to be heated by a heating unit so that the surface temperature is kept at a predetermined temperature, and a pressurizing belt 42 that rotates in contact with the heating roller 41 at a desired pressure. In the fixing device 40, a contact part between the heating roller 41 and the pressurizing belt 42 serves as a fixing nip N that performs a desired fixing process (heating and pressurizing). The fixing device 40 is described later in detail.

The paper feeding device 50 is arranged below the image forming devices 10 (Y, M, C, K). For example, the paper feeding device 50 includes a single (or a plurality of) paper container 52 containing sheets of recording paper 5 of a desired size and type that are stacked on a stacking plate 51, and a sending device 53 that sends the sheets of recording paper 5 one by one from the paper container 52. For example, the paper container 52 is drawable at the front of the apparatus body 1a (side facing a user during an operation).

Examples of the recording paper 5 include plain paper and thin paper such as tracing paper for use in an electrophotographic copying machine or printer, and an OHP sheet that is a transparent film medium made of a synthetic resin (such as PET). To further improve the smoothness of a fixed image surface, it is desirable that the surface of the recording paper 5 be as smooth as possible. For example, coated paper obtained by coating the surface of plain paper with a resin or the like and so-called thick paper such as art paper for printing whose basis weight is relatively large may be used suitably.

A paper feed path 57 formed of a single (or a plurality of) paper transport roller pair 54 and transport guide members 55 and 56 that transport, to the second transfer position T2, the recording paper 5 sent out from the paper feeding device 50 is provided between the paper feeding device 50 and the second transfer device 30. In the paper feed path 57, the paper transport roller pair 54 arranged immediately upstream of the second transfer position T2 is, for example, a pair of rollers that adjust a timing to transport the recording paper 5 (registration rollers).

A paper transport path 59 formed of, for example, a transport guide member 58 that transports, to the fixing device 40, the recording paper 5 sent out from the second transfer device 30 is provided between the second transfer device 30 and the fixing device 40.

A paper output path 65 including a paper transport roller pair 61, a paper output roller pair 62, and transport guide members 63 and 64 that output the recording paper 5 to which the toner images are fixed by the fixing device 40 to a paper output part 60 arranged at the top of the apparatus body 1a is provided on a downstream side of the fixing device 40.

In FIG. 1, reference symbol 100 represents a control device that is an example of a control unit that controls an overall operation of the image forming apparatus 1. Although illustration is omitted, the control device 100 includes a central processing unit (CPU), a read only memory (ROM), a random access memory (RAM), a bus connecting the CPU, the ROM, and the like, and a communication interface.

### <Basic Operation of Image Forming Apparatus>

A basic image forming operation to be performed by the image forming apparatus 1 is described below.

Description is made of an image forming operation to be performed when a full-color image that is a combination of four-color (Y, M, C, K) toner images is formed by using the four image forming devices 10 (Y, M, C, K). A basically similar image forming operation is performed also when an image that is a monochrome toner image or a combination of toner images of a plurality of colors is formed by using one or more image forming devices 10 out of the four image forming devices 10 (Y, M, C, K).

When the image forming apparatus 1 has received command information for requesting the image forming operation (printing), the four image forming devices 10 (Y, M, C, K), the intermediate transfer device 20, the second transfer device 30, the fixing device 40, and the like are activated under control of the control device 100.

In each image forming device 10 (Y, M, C, K), the photoconductor drum 11 first rotates in the direction indicated by the arrow A and the charging device 12 charges the surface of the photoconductor drum 11 at a desired polarity (negative polarity in the first exemplary embodiment) and at a desired potential. Then, the exposing device 13 irradiates the charged surface of the photoconductor drum 11 with light emitted based on an image signal obtained such that image information input to the image forming apparatus 1 is converted into each color component (Y, M, C, K). Thus, an electrostatic latent image of each color component is formed on the surface with a desired potential difference.

Then, each developing device 14 (Y, M, C, K) performs development such that toner of a corresponding color (Y, M, C, K) that is charged at a desired polarity (negative polarity) is supplied and electrostatically adheres to the electrostatic latent image of each color component that is formed on the photoconductor drum 11. Through the development, the electrostatic latent image of each color component that is formed on the photoconductor drum 11 is developed into a toner image of each of the four colors (Y, M, C, K) with the toner of the corresponding color.

When the toner images of the respective colors that are formed on the photoconductor drums 11 of the image forming devices 10 (Y, M, C, K) are transported to the first transfer positions T1, the first transfer devices 15 firstly transfer the toner images of the respective colors so as to sequentially superpose the toner images on the intermediate transfer belt 21 of the intermediate transfer device 20 that rotates in the direction indicated by the arrow B.

In each image forming device 10 (Y, M, C, K) that has finished the first transfer, the drum cleaning device 16 cleans the surface of the photoconductor drum 11 by removing adherents in a scraping manner. Thus, the image forming device 10 (Y, M, C, K) is ready for a subsequent image forming operation.

Then, the intermediate transfer device 20 carries the firstly transferred toner images and transports the toner images to the second transfer position T2 through the rotation of the intermediate transfer belt 21. The paper feeding device 50 sends desired recording paper 5 to the paper feed path 57 in synchronization with the image forming operation. In the paper feed path 57, the paper transport roller pair 54 serving as the registration rollers feeds the recording paper 5 to the second transfer position T2 in synchronization with a transfer timing.

At the second transfer position T2, the second transfer roller 31 secondly transfers the toner images on the intermediate transfer belt 21 collectively onto the recording paper 5. In the intermediate transfer device 20 that has finished the second transfer, the belt cleaning device 26 cleans the surface of the intermediate transfer belt 21 by removing adherents such as toner remaining on the surface after the second transfer.

Then, the recording paper 5 where the toner images are secondly transferred is released from the intermediate transfer belt 21 and the second transfer roller 31 and then transported to the fixing device 40 along the paper transport path 59. In the fixing device 40, the unfixed toner images are fixed to the recording paper 5 after the second transfer through a necessary fixing process (heating and pressurizing) by causing the recording paper 5 to enter and pass through the fixing nip N between the rotating heating roller 41 and the rotating pressurizing belt 42. The recording paper 5 after the fixing is output to the paper output part 60 provided at the top of the apparatus body 1a via the paper output path 65 by the paper output roller pair 62.

Through the operation described above, a full-color image that is a combination of the toner images formed with four-color toners T (Y, M, C, K) is output.

### <Structure of Fixing Device>

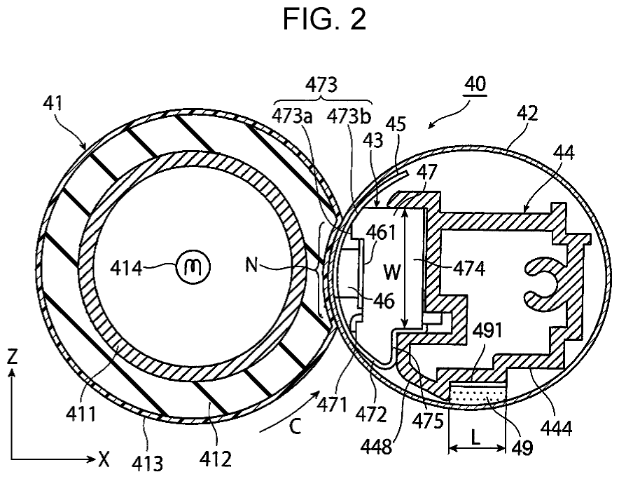

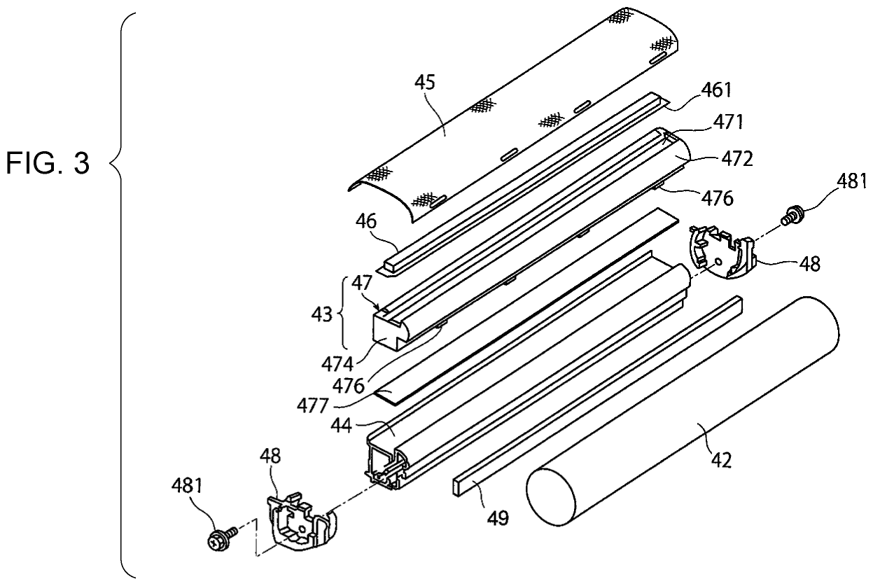

The fixing device 40 is a so-called free belt nip fixing device. As illustrated in FIG. 2 and FIG. 3, the fixing device 40 roughly includes the rotary heating roller 41 that is an example of a first fixing unit, the pressurizing belt 42 that is an example of a second fixing unit formed of an endless belt, a pressurizing member 43 that is an example of a pressurizing unit arranged on an inner side of the pressurizing belt 42 to bring the pressurizing belt 42 into press contact with the surface of the heating roller 41, a holding member 44 that is an example of a holding unit that holds the pressurizing member 43, a sliding sheet 45 that is an example of a sheet unit interposed between the pressurizing belt 42 and the pressurizing member 43 to reduce a sliding resistance, and a felt member 49 that is an example of a lubricant retaining unit arranged at a position including a lowermost point of the pressurizing belt 42 in the vertical direction to retain a lubricant to be supplied to the inner peripheral surface of the pressurizing belt 42.

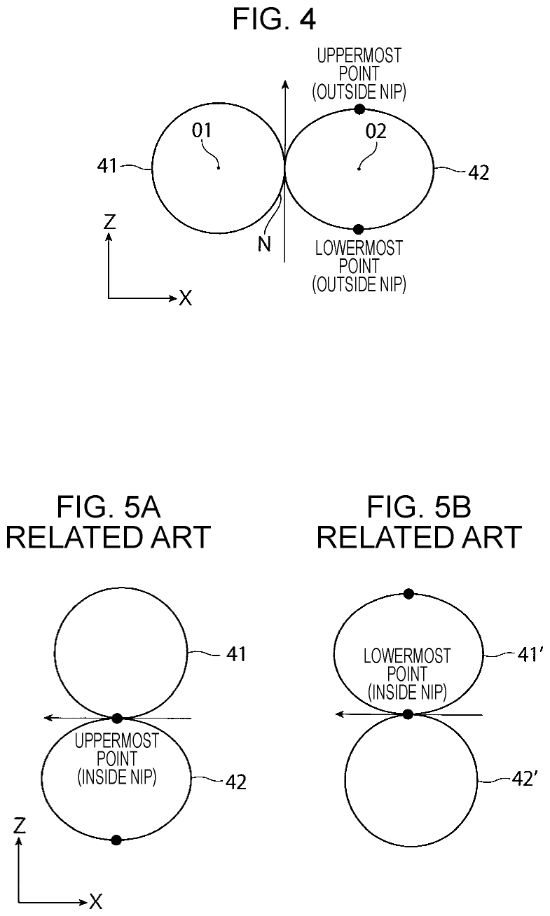

As illustrated in FIG. 4, the heating roller 41 and the pressurizing belt 42 are in contact (press contact) with each other at a position except an uppermost point and a lowermost point of the pressurizing belt 42 in the vertical direction Z to form the fixing nip N. More specifically, when the outer profiles of the heating roller 41 and the pressurizing belt 42 are approximated to circles or ellipses defined about points O1 and O2, respectively, the fixing nip N is arranged at a position corresponding to nine o'clock in a clockwise direction except the uppermost point and the lowermost point of the pressurizing belt 42 in the vertical direction Z. In this exemplary embodiment, the heating roller 41 and the pressurizing belt 42 are arranged in the width direction X that intersects the vertical direction Z and the fixing nip N is located at the end of the pressurizing belt 42 near the heating roller 41 in the width direction X.

As described later, the fixing nip N of the fixing device 40 is arranged at the position except the uppermost point and the lowermost point in the vertical direction Z in consideration of influence of gravity on the lubricant to be supplied to the inner surface of the pressurizing belt 42. In other words, the fixing nip N of the fixing device 40 is not located at the uppermost point or the lowermost point of the pressurizing belt 42 in the vertical direction Z. Thus, this exemplary embodiment excludes a fixing device 40 in which the fixing nip N is located at the uppermost point or the lowermost point of the pressurizing belt 42 or a heating belt 41′ in the vertical direction Z as illustrated in FIGS. 5A and 5B by arranging the heating roller 41 and the pressurizing belt 42 on upper and lower sides in the vertical direction Z or arranging the heating belt 41′ and a pressurizing roller 42′ on upper and lower sides in the vertical direction Z.

The recording paper 5 where the unfixed toner images are transferred at the second transfer position T2 of the intermediate transfer device 20 is transported substantially upward in the vertical direction Z along the paper transport path 59 formed of, for example, the transport guide member 58 by transport forces of the belt support roller 25 and the second transfer roller 31 to enter the fixing nip N of the fixing device 40.

The position of the fixing nip N is directly related to a transport direction of the recording paper 5 in the fixing device 40. The transport direction of the recording paper 5 in the fixing device 40 is approximated to a direction of a tangent to the heating roller 41 and the pressurizing belt 42 arranged in press contact with each other. If the transport direction of the recording paper 5 is a direction corresponding to the vertical direction, the fixing nip N is located at the end of the pressurizing belt 42 in the width direction X as illustrated in FIG. 4. If the transport direction of the recording paper 5 is a direction corresponding to the width direction X, the fixing nip N is located at the uppermost point or the lowermost point of the pressurizing belt 42 or the heating belt 41′ in the vertical direction as illustrated in FIGS. 5A and 5B.

In the first exemplary embodiment, as illustrated in FIG. 2, the heating roller 41 and the pressurizing belt 42 are arranged in the width direction X and the fixing nip N that is a press contact part between the heating roller 41 and the pressurizing belt 42 is located at the end of the pressurizing belt 42 in the width direction X.

The heating roller 41 includes a cylindrical metal core 411 made of a metal such as stainless steel, aluminum, or iron (thin high-tension steel pipe), an elastic layer 412 that coats the outer periphery of the metal core 411 and is made of an elastic body such as silicone rubber or fluorocarbon rubber having a heat resistance, and a thin release layer 413 that coats the surface of the elastic layer 412 and is made of polytetrafluoroethylene (PTFE), perfluoroalkoxy alkane (PFA), or the like. A halogen lamp 414 is arranged in the heating roller 41 as an example of the heating unit (heat source). The heating roller 41 is driven by a driving device (not illustrated) to rotate in a direction indicated by an arrow C.

The surface temperature of the heating roller 41 is detected by a temperature sensor (not illustrated). The heating roller 41 is heated so that its surface has a desired fixing temperature (for example, about 170° C.) by controlling energization of the halogen lamp 414 by using a temperature control circuit (not illustrated) based on a detection result from the temperature sensor.

As illustrated in FIG. 2 and FIG. 3, the pressurizing belt 42 is a thin cylindrical endless belt. The pressurizing belt 42 includes a base layer, an elastic layer that coats the surface of the base layer, and a release layer that coats the surface of the elastic layer. The pressurizing belt 42 may include a base layer and a release layer that directly coats the surface of the base layer. The base layer is made of a synthetic resin such as polyimide, polyamide, or polyamide-imide having a heat resistance, or a metal such as stainless steel, nickel, or copper. The elastic layer is made of an elastic body such as silicone rubber or fluorocarbon rubber having a heat resistance. The release layer is made of polytetrafluoroethylene (PTFE), perfluoroalkoxy alkane (PFA), or the like. For example, the thickness of the pressurizing belt 42 may be set to about 50 to 200 μm.

The pressurizing member 43 that is the example of the pressurizing unit is arranged on the inner side of the pressurizing belt 42. The pressurizing member 43 includes a pressurizing pad 46 that is an example of a first pressurizing unit that pressurizes the pressurizing belt 42 toward the surface of the heating roller 41, and a support member 47 that is an example of a second pressurizing unit that pressurizes the pressurizing belt 42 toward the surface of the heating roller 41 while supporting the pressurizing pad 46.

The pressurizing pad 46 is formed into an elongated rectangular parallelepiped shape that is rectangular in cross section and is made of an elastic body such as silicone rubber or fluorocarbon rubber having a heat resistance. An elongated rectangular plate 461 that is a thin metal plate made of stainless steel or the like is firmly attached to the back of the pressurizing pad 46 by means of bonding or the like. The width of the plate 461 is set larger than that of the pressurizing pad 46. The plate 461 supports the pressurizing pad 46 and functions as a positioning member to be used when the pressurizing pad 46 is attached to the support member 47.

The support member 47 may be formed by using, as a material, a synthetic resin such as polyphenylene sulfide (PPS), polyimide, polyester, or polyamide having a heat resistance and a stiffness, or a metal such as iron, aluminum, or stainless steel.

As illustrated in FIG. 2 and FIG. 3, the support member 47 is formed into an elongated rectangular parallelepiped shape that is substantially rectangular in cross section. A recess 471 in which the pressurizing pad 46 is received is provided on the surface of the support member 47 that faces the heating roller 41. The pressurizing pad 46 is received in a state in which the plate 461 arranged on its back is in close contact with the inner surface of the recess 471.

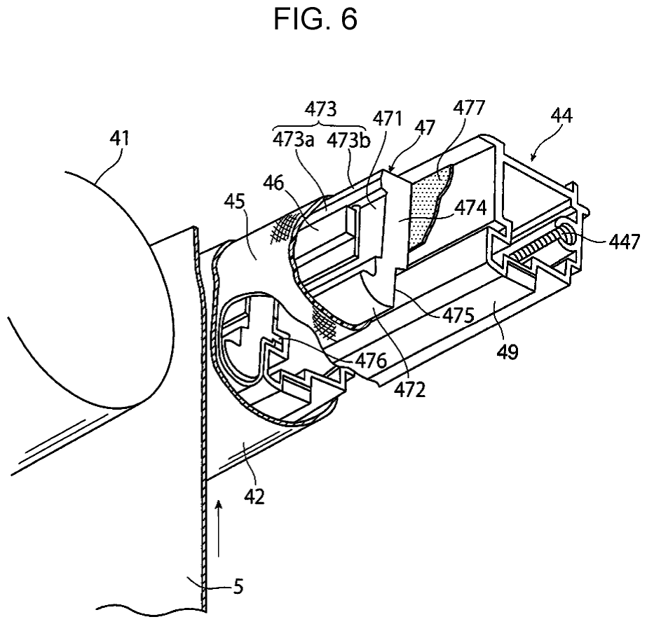

As illustrated in FIG. 6, a guide part 472 that guides the pressurizing belt 42 to the fixing nip N is provided in the support member 47 at the upstream end of the recess 471 in a rotating direction of the pressurizing belt 42. The outer peripheral surface of the guide part 472 is formed into a curved shape.

In the support member 47, a release part 473 is formed at the downstream end of the recess 471 in the rotating direction of the pressurizing belt 42. The release part 473 includes a flat part 473a that is a flat surface near the pressurizing pad 46, and an inclined part 473b formed on a downstream side of the flat part 473a in the rotating direction of the pressurizing belt 42. As illustrated in FIG. 6, the release part 473 brings the pressurizing belt 42 into press contact with the heating roller 41 to deform the elastic layer 412 of the heating roller 41 into a recessed shape, thereby releasing the recording paper 5 that has passed through the fixing nip N from the heating roller 41 owing to the stiffness of the recording paper 5. For convenience, FIG. 2 illustrates a state before the pressurizing pad 46, the pressurizing belt 42, and the like are deformed.

As illustrated in FIG. 2, an attachment part 474 where the support member 47 is attached to the holding member 44 is provided at a portion of the support member 47 that is opposite to the heating roller 41. The attachment part 474 of the support member 47 is formed into a shape that protrudes away from the heating roller 41 such that a width W is smaller than that of a portion near the heating roller 41 with respect to a step 475 provided at the upstream end of the guide part 472 in the rotating direction of the pressurizing belt 42.

As illustrated in FIG. 3, a plurality of engagement protrusions 476 that engage with the end of the sliding sheet 45 are provided in a longitudinal direction on the end surface of the attachment part 474 of the support member 47 that is opposite to the heating roller 41.

As illustrated in FIG. 6, the holding member 44 holds the pressurizing pad 46 and the support member 47. The pressurizing pad 46 and the support member 47 receive a reaction force from the heating roller 41 because the pressurizing pad 46 and the support member 47 are in press contact with the surface of the heating roller 41. The stiffness of the holding member 44 is increased so that the holding member 44 is hardly deflected in the longitudinal direction by the reaction force received from the heating roller 41. For example, the holding member 44 is formed into an irregular sectional shape analogous to a substantially rectangular frame with a large moment of inertia of area by drawing a metal such as aluminum or stainless steel. The holding member 44 only needs to have such a material and structure that the holding member 44 is hardly deflected in the state in which the pressurizing pad 46 and the support member 47 are in press contact with the heating roller 41. For example, the holding member 44 may be formed by combining a synthetic resin or the like with a plate formed into an L-shape in cross section and made of a metal such as stainless steel or aluminum.

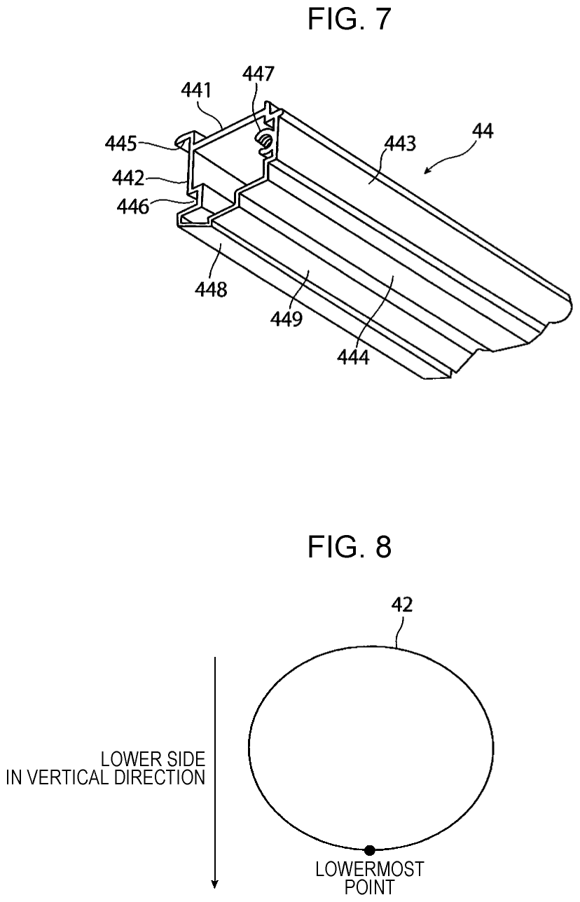

As illustrated in FIG. 2 and FIG. 7, the holding member 44 includes a flat top plate part 441 located at the upper end, a substantially flat left plate part 442 located on a side of the top plate part 441 near the heating roller 41, a substantially flat right plate part 443 located on a side of the top plate part 441 that is opposite to the heating roller 41, and a bottom plate part 444 located at the lower end.

As illustrated in FIG. 7, the left plate part 442 of the holding member 44 is provided with a recess 445 open to the heating roller 41. As illustrated in FIG. 2 and FIG. 6, the attachment part 474 of the support member 47 is fitted to the recess 445 of the holding member 44 via an elastic sheet 477 having a heat resistance. In the left plate part 442 of the holding member 44, a groove 446 into which the engagement protrusions 476 of the support member 47 are inserted is formed at a position corresponding to the lower end of the recess 445.

As illustrated in FIG. 3, female screws 447 are formed integrally with the inner side surface of the right plate part 443 of the holding member 44 so that guide members 48 that guide both longitudinal ends of the pressurizing belt 42 are attached by using male screws 481.

In the bottom plate part 444 of the holding member 44, a relatively short curved guide part 448 that guides the pressurizing belt 42 toward the fixing nip N is formed in a circumferential direction of the pressurizing belt 42. As illustrated in FIG. 2, the guide part 448 of the holding member 44 guides the pressurizing belt 42 toward the fixing nip N in cooperation with the guide part 472 of the support member 47.

In the bottom plate part 444 of the holding member 44, an attachment part 449 where the felt member 49 is attached is formed as an upward step on an upstream side of the guide part 448 in the rotating direction of the pressurizing belt 42.

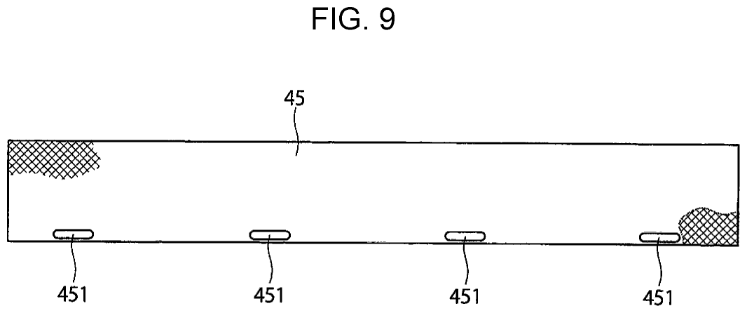

As illustrated in FIG. 9, the sliding sheet 45 is an elongated sheet that is rectangular in plan view. Examples of the sliding sheet 45 to be used include a sheet including a base layer made of a fluorocarbon resin such as polytetrafluoroethylene (PTFE), and a texture such as a woven fabric or a knitted fabric made of aramid fibers or the like and laminated on the front surface of the base layer or on both front and back surfaces thereof. As the sliding sheet 45, there may be used a sheet including only a base layer made of a fluorocarbon resin such as polytetrafluoroethylene (PTFE). The thickness of the sliding sheet may be set to about 100 to 200 μm.

At the upstream end of the sliding sheet 45 in the rotating direction of the pressurizing belt 42, a plurality of oblong engagement holes 451 are formed in the longitudinal direction. As illustrated in FIG. 2 and FIG. 6, the sliding sheet 45 is attached such that the plurality of engagement holes 451 engage with the engagement protrusions 476 provided on the side surface of the support member 47. The sliding sheet 45 extends, via the guide part 472 of the support member 47, to the fixing nip N where the pressurizing pad 46 and the heating roller 41 are in press contact with each other in a state in which an upstream portion in the rotating direction of the pressurizing belt 42 is sandwiched in a space between the support member 47 and the holding member 44. The downstream end of the sliding sheet 45 in the rotating direction of the pressurizing belt 42 extends by a desired length beyond the release part 473 of the support member 47.

The first exemplary embodiment provides the felt member 49 that has a heat resistance and is the example of the lubricant retaining unit arranged at the position including the lowermost point of the pressurizing belt 42 in the vertical direction to retain the lubricant to be supplied to the inner peripheral surface of the pressurizing belt 42.

As illustrated in FIG. 2 and FIG. 7, in the bottom plate part 444 of the holding member 44, as described above, the attachment part 449 where the felt member 49 is attached is provided on the upstream side of the guide part 448 in the rotating direction of the pressurizing belt 42 so as to have a desired length L in the circumferential direction of the pressurizing belt 42 over a range including the lowermost point of the pressurizing belt 42 in the vertical direction Z. On the attachment part 449, the felt member 49 is provided by means of, for example, adhesion that uses a double coated tape 491 having a heat resistance or bonding that uses an adhesive. As a result, the felt member 49 is arranged in the circumferential direction of the pressurizing belt 42 at the position including the lowermost point of the pressurizing belt 42 in the vertical direction Z. The description “arranged in the circumferential direction of the pressurizing belt 42” refers to a state in which the felt member 49 is pushed against the inner peripheral surface of the pressurizing belt 42 to have a curved shape with the fixing device 40 assembled. That is, the felt member 49 is located at the lowermost point of the pressurizing belt 42 in the vertical direction Z and has some length while being in contact with the inner peripheral surface of the pressurizing belt 42 in conformity therewith. The felt member 49 slightly protrudes toward the pressurizing belt 42 from the lower end surface of the bottom plate part 444 of the holding member 44. The felt member 49 is impregnated in advance with about 3 g of the lubricant to be supplied to the inner peripheral surface of the pressurizing belt 42 while being applied thereto. Examples of the lubricant to be used include amino-modified silicone oil having a viscosity of 100 to 350 cs. Although the lubricant is supplied to the inner peripheral surface of the pressurizing belt 42 while being applied thereto by being impregnated into the felt member 49 in advance, the lubricant is not limited thereto and may originally be applied to the inner peripheral surface of the pressurizing belt 42.

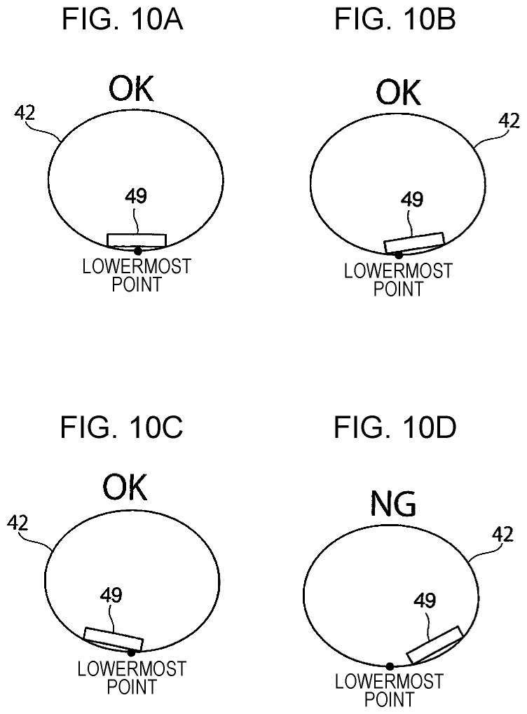

As illustrated in FIG. 8, the position including the lowermost point of the pressurizing belt 42 in the vertical direction Z encompasses a case in which a part of the felt member 49 in the circumferential direction of the pressurizing belt 42 includes the lowermost point in the vertical direction Z on a circle of circulation of the pressurizing belt 42. For example, as illustrated in FIG. 10A, the felt member 49 is arranged so that the center of the felt member 49 in the circumferential direction of the pressurizing belt 42 coincides with the lowermost point in the vertical direction Z on the circle of circulation of the pressurizing belt 42.

The arrangement of the felt member 49 is not limited to the arrangement described above. As illustrated in FIGS. 10B and 10C, the arrangement encompasses a case in which the felt member 49 is arranged with a shift to an upstream side or a downstream side in the rotating direction of the pressurizing belt 42. If the felt member 49 is arranged, as illustrated in FIG. 10B, at a position including the lowermost point of the pressurizing belt 42 in the vertical direction Z with a shift to a side opposite to the fixing nip N across the lowermost point in the circumferential direction of the pressurizing belt 42, it is possible to reduce the occurrence of a case in which the lubricant supplied to the inner peripheral surface of the pressurizing belt 42 leaks from the side opposite to the fixing nip N where the lubricant is likely to move in the vertical direction Z.

As illustrated in FIG. 10D, the arrangement of the felt member 49 excludes a case in which a part of the felt member 49 in the circumferential direction of the pressurizing belt 42 does not include the lowermost point of the pressurizing belt 42 in the vertical direction but the felt member 49 is completely displaced to the upstream side or the downstream side in the rotating direction of the pressurizing belt 42.

### <Operation of Fixing Device>

In the fixing device 40 according to this exemplary embodiment, as illustrated in FIG. 2, the heating roller 41 is heated by the halogen lamp 414 and is driven by the driving device (not illustrated) to rotate in the direction indicated by the arrow C in synchronization with the start of the image forming operation of the image forming apparatus 1.

In the fixing device 40, the pressurizing belt 42 in press contact with the heating roller 41 at the fixing nip N is rotated along with the rotation of the heating roller 41. The lubricant is uniformly applied to the inner peripheral surface of the pressurizing belt 42 by the felt member 49. The pressurizing belt 42 is in contact with the surface of the heating roller 41 at the fixing nip N and therefore the temperature of the pressurizing belt 42 increases due to thermal conduction from the heating roller 41. When the temperature of the pressurizing belt 42 increases, the temperature of the lubricant applied to the inner peripheral surface of the pressurizing belt 42 increases and the viscosity of the lubricant decreases.

In the fixing device 40, the recording paper 5 where unfixed toner images are transferred is heated and pressurized through the fixing nip N where the heating roller 41 and the pressurizing belt 42 are in contact with each other, thereby fixing the unfixed toner images to the surface of the recording paper 5. If images are formed on a plurality of sheets of recording paper 5, the fixing process of the fixing device 40 is repeated for the number of times corresponding to the number of sheets of recording paper 5.

When the fixing device 40 has finished the fixing operation, the energization of the halogen lamp 414 serving as the heat source is stopped and the rotational driving of the heating roller 41 is stopped.

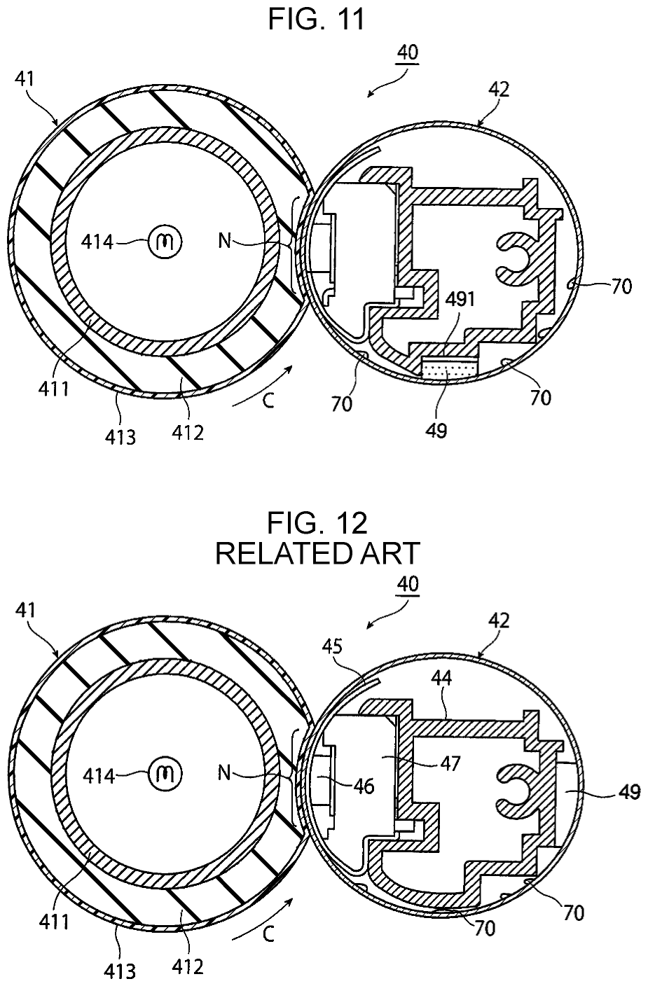

Immediately after the fixing device 40 has finished the fixing operation, the temperatures of the heating roller 41 and the pressurizing belt 42 remain high. As illustrated in FIG. 11, a lubricant 70 applied to the inner peripheral surface of the pressurizing belt 42 has a low viscosity due to the high temperature state and moves downward in the vertical direction Z along the inner peripheral surface of the pressurizing belt 42 due to the influence of the gravity.

In the fixing device 40 according to the first exemplary embodiment, the felt member 49 is arranged at the position including the lower end of the pressurizing belt 42 in the vertical direction Z as illustrated in FIG. 11. Immediately after the fixing operation has been finished, the lubricant 70 that has a low viscosity due to the high temperature state and has moved downward in the vertical direction Z along the inner peripheral surface of the pressurizing belt 42 due to the influence of the gravity is impregnated into and retained by the felt member 49. In the fixing device 40, the leakage of the lubricant 70 to the outside from both axial ends of the pressurizing belt 42 is prevented or reduced.

In a related-art fixing device 40 illustrated in FIG. 12, the felt member 49 is arranged at the end of the pressurizing belt 42 that is opposite to the fixing nip N. Immediately after the fixing operation has been finished, the lubricant 70 that has a low viscosity due to the high temperature state and has moved to the lower end in the vertical direction Z along the inner peripheral surface of the pressurizing belt 42 due to the influence of the gravity may leak to the outside from the axial ends of the pressurizing belt 42.

### Second Exemplary Embodiment

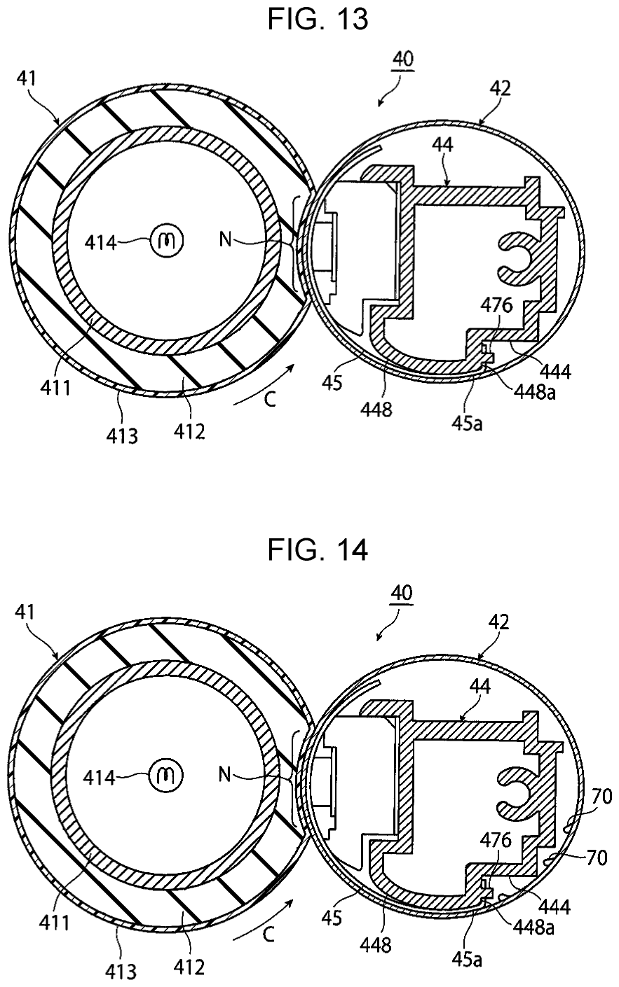

FIG. 13 is a structural view illustrating a fixing device according to a second exemplary embodiment. In the fixing device 40 according to the second exemplary embodiment, the felt member serving as the lubricant retaining unit is not provided but the sliding sheet 45 functions as the lubricant retaining unit.

That is, in the fixing device 40 according to the second exemplary embodiment, as illustrated in FIG. 13, an upstream end 45a of the sliding sheet 45 in the rotating direction of the pressurizing belt 42 is not located between the support member 47 and the holding member 44 but extends to a region including the lowermost point of the pressurizing belt 42 in the vertical direction Z.

In the illustrated second exemplary embodiment, the upstream end 45a of the sliding sheet 45 in the rotating direction of the pressurizing belt 42 extends to the upstream side in the rotating direction of the pressurizing belt 42 beyond the lowermost point of the pressurizing belt 42 in the vertical direction Z.

In the bottom plate part 444 of the holding member 44, the guide part 448 is provided at a position including the lowermost point of the pressurizing belt 42 in the vertical direction Z so as to extend to the upstream side in the rotating direction of the pressurizing belt 42. At the upstream end of the guide part 448 in the rotating direction of the pressurizing belt 42, a step 448a is formed by bending the guide part 448 to the inner side of the pressurizing belt 42. The plurality of engagement protrusions 476 that engage with the engagement holes 451 of the sliding sheet 45 are provided in the longitudinal direction on the side surface of the step 448a.

The sliding sheet 45 is fixed such that the upstream end 45a in the rotating direction of the pressurizing belt 42 engages with the engagement protrusions 476 through the engagement holes 451. The sliding sheet 45 is arranged so that the downstream portion in the rotating direction of the pressurizing belt 42 extends, via the guide part 448 of the holding member 44, to the fixing nip N where the pressurizing pad 46 and the heating roller 41 are in press contact with each other and protrudes from the release part 473 of the support member 47 by a desired length.

When the fixing device 40 according to the second exemplary embodiment has finished the fixing operation, the energization of the halogen lamp 414 serving as the heat source is stopped and the rotational driving of the heating roller 41 is stopped.

Immediately after the fixing device 40 has finished the fixing operation, the temperatures of the heating roller 41 and the pressurizing belt 42 remain high. As illustrated in FIG. 14, the lubricant applied to the inner peripheral surface of the pressurizing belt 42 has a low viscosity due to the high temperature state and moves downward in the vertical direction Z along the inner peripheral surface of the pressurizing belt 42 due to the influence of the gravity.

In the fixing device 40 according to the second exemplary embodiment, the sliding sheet 45 extends to the position including the lower end of the pressurizing belt 42 in the vertical direction Z as illustrated in FIG. 14. Immediately after the fixing operation has been finished, the lubricant that has a low viscosity due to the high temperature state and has moved downward in the vertical direction Z along the inner peripheral surface of the pressurizing belt 42 due to the influence of the gravity is retained in a space between the sliding sheet 45 and the pressurizing belt 42 by a capillary action. In the fixing device 40, the leakage of the lubricant to the outside from both axial ends of the pressurizing belt 42 is prevented or reduced.

In the second exemplary embodiment, the lubricant retaining unit such as the felt member 49 except the sliding sheet 45 is not required and therefore the number of components is reduced.

### Third Exemplary Embodiment

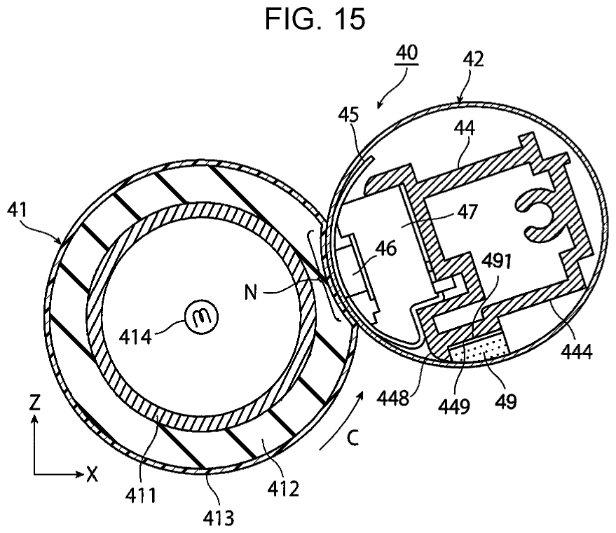

FIG. 15 is a structural view illustrating a fixing device according to a third exemplary embodiment. In the fixing device 40 according to the third exemplary embodiment, the fixing nip N is not arranged at the end of the pressurizing belt 42 in the width direction X but is arranged at a position except the end of the pressurizing belt 42 in the width direction X.

That is, in the third exemplary embodiment, as illustrated in FIG. 15, the heating roller 41 and the pressurizing belt 42 are inclined downward with respect to the width direction X and the fixing nip N is arranged at a position except the uppermost point and the lowermost point of the pressurizing belt 42 in the vertical direction Z.

More specifically, in the fixing device 40 according to the third exemplary embodiment, the heating roller 41 and the pressurizing belt 42 are inclined with respect to the width direction X so that the heating roller 41 is located at a lower level in height. Along with this, the fixing nip N where the heating roller 41 and the pressurizing belt 42 are in press contact with each other is located obliquely below the end of the pressurizing belt 42 in the width direction X.

Compared with the first exemplary embodiment, the felt member 49 is arranged at a position shifted to the downstream side of the holding member 44 in the rotating direction of the pressurizing belt 42 so as to include the lowermost point of the pressurizing belt 42 in the vertical direction Z.

In the fixing device 40 according to the third exemplary embodiment, the fixing nip N is located obliquely below the end of the pressurizing belt 42 in the width direction X. Thus, the leakage of the lubricant from the axial ends of the pressurizing belt 42 is prevented or reduced even if the recording paper 5 is transported obliquely with respect to the vertical direction Z.

The exemplary embodiments described above are directed to the case in which the oil such as silicone oil is used as the lubricant. The lubricant is not limited thereto. Examples of the lubricant to be used also include grease that is liquid lubricating oil. The grease is composed of base oil, a thickener such as a calcium soap or a sodium soap, and an additive. The grease has a higher viscosity and a lower fluidity than the oil such as silicone oil and is therefore a semisolid or semifluid at normal temperature.

The exemplary embodiments described above are directed to the case in which the first fixing unit is the heating roller and the second fixing unit formed of the endless belt is the pressurizing belt. The components are not limited thereto. The first fixing unit may be a pressurizing roller and the second fixing unit formed of the endless belt may be a heating belt. Alternatively, the first fixing unit may be a pressurizing belt and the second fixing unit formed of the endless belt may be a heating belt. The heating unit may be provided in any one of the first and second fixing units or in both the first and second fixing units.

In the exemplary embodiments described above, the color image forming apparatus including the yellow (Y), magenta (M), cyan (C), and black (K) image forming devices is described as the image forming apparatus. A monochrome image forming apparatus is similarly applicable as the image forming apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. A fixing device, comprising:
a rotary first fixing unit;
a second fixing unit that is formed of an endless belt and is in contact with the first fixing unit at a position other than an uppermost point of the second fixing unit and a lowermost point of the second fixing unit in a vertical direction to form a fixing nip; and
a lubricant retaining unit arranged at a position including the lowermost point of the second fixing unit to retain a lubricant to be supplied to an inner peripheral surface of the belt.

2. The fixing device according to claim 1, wherein the lubricant retaining unit is arranged in a circumferential direction of the belt at the position including the lowermost point of the second fixing unit.

3. The fixing device according to claim 2, wherein the lubricant retaining unit is arranged at the position which a projection of the lubricant retaining unit along the vertical direction includes the lowermost point of the second fixing unit and the lubricant retaining unit is shifted to a side opposite to the fixing nip across the lowermost point of the second fixing unit in the circumferential direction of the belt.

4. The fixing device according to claim 1, wherein the lubricant retaining unit is located at the position which the projection of the lubricant retaining unit along the vertical direction includes including the lowermost point of the second fixing unit.

5. The fixing device according to claim 2, wherein the lubricant retaining unit is located at the position which the projection of the lubricant retaining unit along the vertical direction includes including the lowermost point of the second fixing unit.

6. The fixing device according to claim 3, wherein the lubricant retaining unit is located at the position which the projection of the lubricant retaining unit along the vertical direction includes including the lowermost point of the second fixing unit.

7. The fixing device according to claim 1, further comprising a sheet-shaped sliding unit arranged on an inner side of the belt to reduce a sliding resistance of the belt at the fixing nip,
wherein the sliding unit is the lubricant retaining unit.

8. The fixing device according to claim 7, wherein the sliding unit is arranged in a region from the lowermost point of the second fixing unit to the fixing nip.

9. An image forming apparatus, comprising:
an image forming unit that forms an unfixed toner image on a recording medium; and
a fixing unit that fixes the unfixed toner image formed on the recording medium,
wherein the fixing unit comprises the fixing device according to claim 1.

10. A fixing device, comprising:
rotary first fixing means;
second fixing means that is formed of an endless belt and is in contact with the first fixing means at a position other than an uppermost point of the second fixing unit and a lowermost point of the second fixing unit in a vertical direction to form a fixing nip; and
lubricant retaining means arranged at a position including the lowermost point of the second fixing unit to retain a lubricant to be supplied to an inner peripheral surface of the belt.

11. The fixing device according to claim 1, wherein the belt is configured to bent upward in the vertical direction at the lowermost point of the second fixing unit.
